(19) United States
(12) Patent Application Publication
(10) Pub. No.: US 2010/0329245 A1
(43) Pub. Date: Dec. 30, 2010

(54) Transparent Mapping of Cell Streams to Packet Services

(76) Inventors: Mark A. Bordogna, Andover, MA (US); Masoud Mojtahed, Austin, TX (US)

Correspondence Address: Ryan, Mason & Lewis, LLP, 90 Forest Avenue, Locust Valley, NY, 11560, US

(21) Appl. No.: 12/494,654

(22) Filed: Jun. 30, 2009

(51) Int. Cl. H04L 12/66

(52) U.S. Cl. 370/356

(57) ABSTRACT

Data traffic of at least one cell stream of a circuit-switched network is processed for transmission over a packet service of a packet-switched network. At least one processor of a communication system node receives data traffic associated with a plurality of virtual circuits of the cell stream, maps the plurality of virtual circuits as a single unit to an identifier of a particular packet service of the packet-switched network, and transmits the data traffic associated with the virtual circuits over the particular packet service. The mapping of the plurality of virtual circuits as a single unit is implemented without requiring any processing of virtual channel indicators of the respective virtual circuits.

### FIELD OF THE INVENTION

The present invention relates generally to communication systems, and more particularly to techniques for mapping of cell streams to packet services within such systems.

### BACKGROUND OF THE INVENTION

In many communication system applications, it is necessary to carry circuit-switched traffic such as T1/E1 traffic over a packet-switched network such as an Internet Protocol (IP) network. For example, T1/E1 traffic from a SONET/SDH network or other circuit-switched network may be carried in Asynchronous Transfer Mode (ATM) cells using virtual circuits (VCs) that are mapped to packets of an IP network or other packet-switched network.

The circuit-switched traffic may be transported in ATM VCs of the Constant Bit Rate (CBR) type using an approach known as Circuit Emulation Service (CES), as described in “Circuit Emulation Service Interoperability Specification, Version 2.0,” ATM Forum Specification, atm-vtoa-0078.000, January 1997, which is incorporated by reference herein. CES is often used to transfer voice, video or emulated private line services across an ATM network. CES provides emulated private line services using ATM Adaptation Layer 1 (AAL1).

Private line services are an important aspect of modern communication systems, and generally allow an end user to send any type of content across a network, with the network transporting the content in a transparent manner. For example, in a fully circuit-switched network, a typical private line service maps the entire content of a T1/E1 line across the network. It is becoming increasingly apparent that mappings of circuit-switched traffic to packet traffic need to allow for emulated private line service capabilities.

One example of a known approach to mapping of ATM cell streams to packet services of a packet-switched network is disclosed in IETF RFC 4717, J. Martini et al., “Encapsulation Methods for Transport of Asynchronous Transfer Mode (ATM) over MPLS Networks,” December 2006, which is incorporated by reference herein. In this approach, an ATM pseudowire (PW) is used to carry ATM cells over a Multi Protocol Label Switching (MPLS) network. This allows service providers to offer “emulated” ATM services over MPLS networks. Such an emulated ATM service is an example of what is more generally referred to herein as a Pseudowire Emulation Edge to Edge (PWE3) service.

Other known techniques for carrying circuit-switched traffic over a packet-switched network are disclosed in MEF 8, “Implementation Agreement for the Emulation of PDH Circuits over Metro Ethernet Networks,” Metro Ethernet Forum, October 2004, and IETF RFC 4553, A. Vainshtein and Y. J. Stein, “Structure-Agnostic Time Division Multiplexing (TDM) over Packet (SAToP),” June 2006, both of which are incorporated by reference herein.

Conventional mapping techniques such as those described above are problematic in that the techniques can be inefficient in certain applications. For example, the approach described in RFC 4717 performs ATM cell mapping at the Virtual Channel Identifier (VCI) level. Thus, VCI checking is required in the mapping process, resulting in complex ATM processing. Also, it is difficult to add or remove VCIs, as such operations may trigger a need for negotiation of VCIs with the packet service provider. Therefore, this mapping approach does not allow an emulated private line service capability. Also, although the above-noted CES or SAToP approaches both allow emulated private line services, such services are provided at the expense of bandwidth efficiency. For example, in the CES or SAToP approaches, all TDM channels associated with a given T1/E1 line are automatically mapped into a packet stream even if certain of the channels are not currently being used, which leads to bandwidth inefficiency.

Accordingly, a need exists for an improved approach to mapping of cell streams to packet services that avoids the need for VCI checking in the mapping process while also providing higher bandwidth efficiency.

### SUMMARY OF THE INVENTION

Illustrative embodiments of the present invention overcome the above-noted drawbacks of conventional practice by providing improved techniques for mapping of cell streams to packet services in a communication system.

In accordance with an aspect of the invention, data traffic of at least one cell stream of a circuit-switched network is processed for transmission over a packet service of a packet-switched network. At least one processor of a communication system node receives data traffic associated with a plurality of virtual circuits of the cell stream, maps the plurality of virtual circuits as a single unit to an identifier of a particular packet service of the packet-switched network, and transmits the data traffic associated with the virtual circuits over the particular packet service. The mapping of the plurality of virtual circuits as a single unit is implemented without requiring any processing of virtual channel indicators of the respective virtual circuits, and is therefore “transparent” with respect to such indicators.

In a given one of the illustrative embodiments, a link layer processor maps the plurality of virtual circuits as a single unit to a network address which comprises a combination of a physical layer address and a channel identifier, and a network processor coupled to the link layer processor maps the physical layer address and the channel identifier to the identifier of a particular packet service of the packet-switched network.

By way of example, the link layer processor may map the plurality of virtual circuits as a single unit to a network address by forming at least one packet in a first packet format having a payload portion comprising one or more cells and an appended address portion comprising at least a part of the network address.

The network processor may map the network address to the identifier of a particular packet service by processing one or more packets received from the link layer processor in the first packet format to generate one or more packets in a second packet format having a payload portion comprising one or more cells and further having an appended identifier portion comprising at least a part of the packet service identifier.

Advantageously, one or more of the illustrative embodiments each provides improved mapping of cell streams to packet services in a manner that completely avoids the need for VCI checking and provides an emulated private line service capability while also achieving a high level of bandwidth efficiency.

### BRIEF DESCRIPTION OF THE DRAWINGS

FIG. 1 is a block diagram of one possible implementation of a network-based communication system comprising a link layer processor and a network processor.

FIG. 2 is a more detailed view of the link layer processor of the FIG. 1 system.

FIG. 3 is a flow diagram illustrating an exemplary process for mapping of cell streams to packet services in the FIG. 1 system.

FIG. 4 shows a more detailed example of a mapping process involving the link layer processor and network processor of the FIG. 1 system.

FIG. 5 illustrates one possible implementation of a cell interface between the link layer processor and the network processor of the FIG. 1 system.

FIG. 6 shows a packet format for communication over the cell interface of FIG. 5.

### DETAILED DESCRIPTION OF THE INVENTION

The invention will be illustrated herein in conjunction with exemplary communication systems in which cell streams are mapped to packet services. It should be understood, however, that the invention is more generally applicable to any communication system in which it is desirable to provide improved efficiency and performance in emulation of circuit services over packet-switched networks.

FIG. 1 shows a network-based communication system 100 that includes a physical layer device 102 coupled to a link layer processor 104 via an interface 105. The link layer processor 104 is also coupled to a network processor 106, via an interface 107. The link layer processor is coupled to a circuit-switched network 108 via the physical layer device, and is coupled to a packet-switched network 110 via the network processor.

In this embodiment, the physical layer device 102, link layer processor 104 and network processor 106 are part of a network node 112 that may be an edge node of either the circuit-switched network 108 or the packet-switched network 110. Other nodes of the system may of course be configured in a similar manner.

The node 112 further comprises a host processor 114. The host processor is used to configure and control one or more of the other processing elements of the node 112, such as the physical layer device 102, link layer processor 104 and network processor 106. Portions of the host processor functionality may be incorporated into one or more of elements 102, 104 or 106 in alternative embodiments of the invention.

The node 112 may be implemented, by way of example, as a router, switch or other type of network element, or as a portion of such a network element, such as a circuit board or line card comprising multiple integrated circuits.

The physical layer device 102 may comprise, for example, one or more mappers, transceivers or other types of circuitry for interfacing the link layer processor 104 to the circuit-switched network 108. The link layer processor 104 may be implemented as a protocol processor, and the term “link layer processor” as used herein is generally intended to encompass such a protocol processor or more generally any type of processor which performs processing operations associated with a link layer of a network-based system.

Examples of mappers suitable for use as physical layer device 102 include the LSI Hypermapper™, Ultramapper™ and Supermapper™ devices commercially available from LSI Corporation of Allentown, Pa., U.S.A.

The network processor 106 may incorporate certain well-known functionality generally associated with a conventional network processor such as an LSI Advanced PayloadPlus™ network processor in the APP300, APP500 or APP650 product family, also commercially available from LSI Corporation.

Various elements of the node 112 may be implemented, by way of example and without limitation, utilizing a microprocessor, central processing unit (CPU), digital signal processor (DSP), application-specific integrated circuit (ASIC), FPGA, or other type of data processing device, as well as portions or combinations of these and other devices. The link layer processor 104 and network processor 104 may therefore be implemented as respective integrated circuits.

Although the link layer processor 104 and network processor 106 are shown as separate elements in this illustrative embodiment, other embodiments may combine the functionality of the link layer processor and the network processor into a single processing device.

It should again be noted that the particular arrangement of system elements shown in FIG. 1 is by way of illustrative example only. The system 100 may therefore include other elements in addition to or in place of those specifically shown, including one or more elements of a type commonly found in a conventional implementation of such a system.

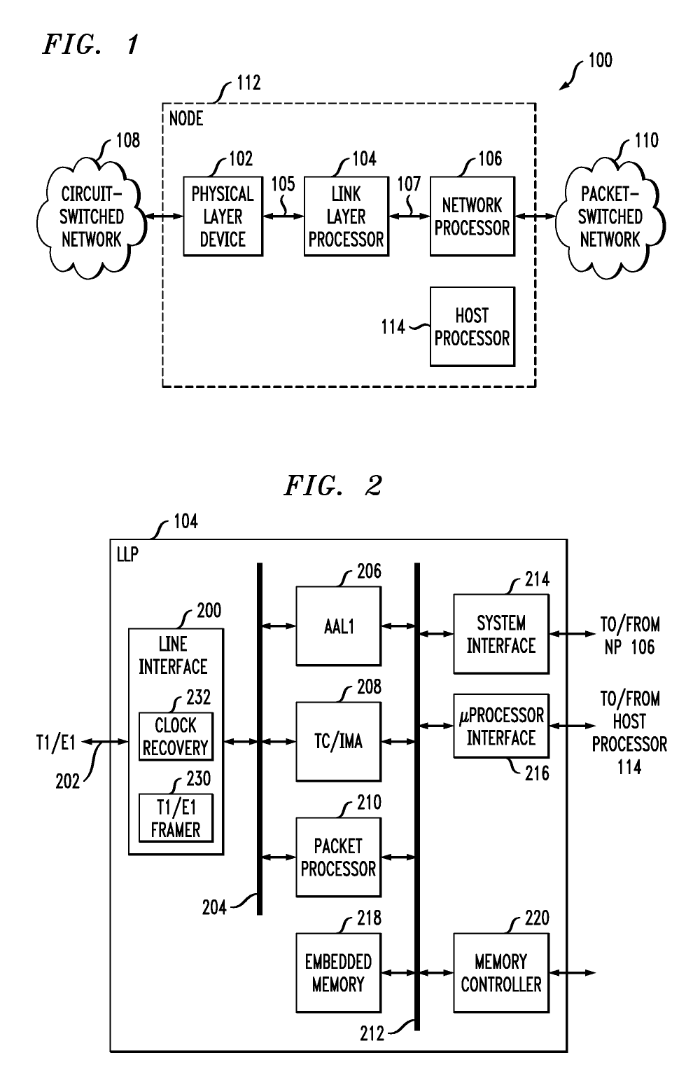

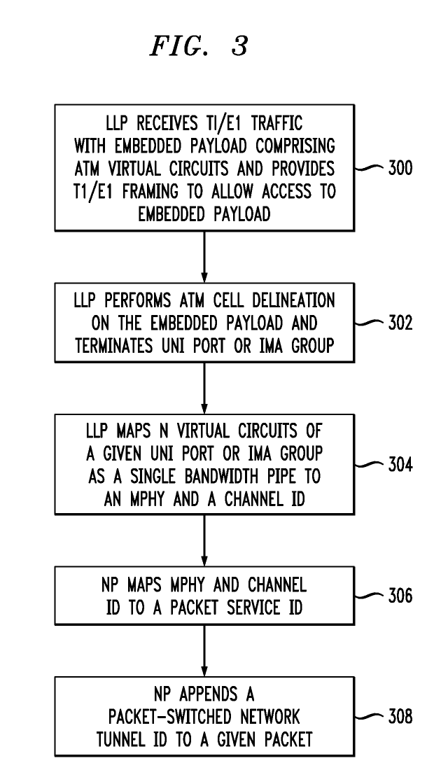

FIG. 2 shows a more detailed view of one possible embodiment of the link layer processor 104 of FIG. 1. In this and subsequent description, the link layer processor will also be referred to by the acronym LLP. The LLP includes a line interface 200 that is adapted to receive T1/E1 traffic having an embedded payload comprising ATM virtual circuits. This traffic is received via a T1/E1 signal line 202. The line interface 200 is coupled via a bus 204 to an AAL1 element 206, a transmission convergence (TC)/inverse multiplexing over ATM (IMA) element 208, and a packet processor 210. These elements are coupled via bus 212 to a system interface 214, a microprocessor interface 216, an embedded memory 218, and a memory controller 220. The system interface 214 provides interconnection between the LLP and the network processor 106, which will also be referred to herein by its acronym NP. The microprocessor interface 216 is coupled to host processor 114. The memory controller 220 may also be coupled to the host processor 114, or to another system element. The line interface 200 includes a T1/E1 framer 230, and a clock recovery element 232.

It is to be appreciated that the particular LLP embodiment shown in FIG. 2 is presented by way of illustrative example only, and a wide variety of other types of processing circuitry may be used in alternative embodiments of the invention.

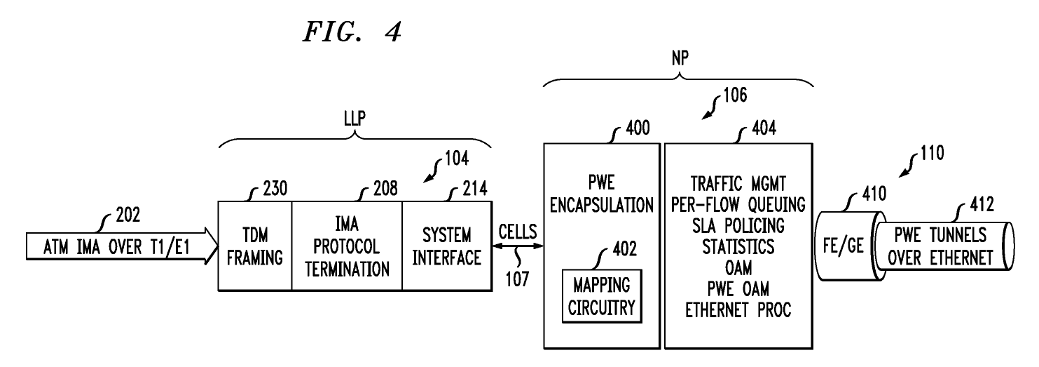

FIG. 3 is a flow diagram illustrating the operation of LLP 104 and NP 106 in processing data traffic of an ATM cell stream carried as an embedded payload of the T1/E1 traffic. The process shown includes steps 300 through 308, with steps 300, 302 and 304 being performed by the LLP and steps 306 and 308 being performed by the NP.

In step 300, the LLP receives T1/E1 traffic with an embedded payload comprising ATM virtual circuits and provides T1/E1 framing to allow access to the embedded payload. The T1/E1 traffic is received via the signal line 202 associated with line interface 200, and the T1/E1 framing is provided by the T1/E1 framer 230. Such framing operations and other conventional aspects of LLP or NP operation are well known to those skilled in the art and therefore will not be described in detail herein.

In step 302, the LLP performs ATM cell delineation on the embedded payload and terminates at least one user network interface (UNI) port or IMA group comprising a plurality of virtual circuits. A given such UNI port of IMA group is assumed to comprise N virtual circuits. The cell delineation and port or group virtual circuit termination is implemented by the TC/IMA element 208.

In step 304, the LLP maps the N virtual circuits of a given UNI port or IMA group as a single bandwidth pipe to an MPHY and a channel identifier (ID). This mapping is performed in the system interface 214. The MPHY is an example of a physical layer address, and the MPHY and channel ID collectively may be viewed as an example of what is more generally referred to herein as a network address. Thus, the LLP in step 304 maps N virtual circuits as a single unit to a network address. This mapping of the N virtual circuits as a single unit does not require any processing of VCIs of the respective virtual circuits. The VCIs may be viewed as examples of what are more generally referred to herein as “virtual channel indicators.”

In step 306, the NP maps the MPHY and channel ID to a packet service ID. The packet service ID is an identifier of a particular packet service of the packet-switched network 110. For example, the particular packet service may be a PWE service supported by the node 112. The NP thus maps the above-noted network address illustratively comprising an MPHY and a channel ID to a packet service ID.

In step 308, the NP appends a tunnel ID of the packet-switched network 110 to one or more packets of the packet service. This may be viewed as an example of one possible approach for the NP to associate the packet service ID with an identifier of a particular tunnel of the packet-switched network. The tunnel may comprise, for example, a PWE tunnel, an IP tunnel or an MPLS tunnel of the packet-switched network 110 and may be transmitted over an Ethernet physical layer, such as a Fast Ethernet (FE) or Gigabit Ethernet (GE) physical layer.

Although not specifically indicated in the flow diagram, data traffic of the N virtual circuits is transmitted by the NP over the packet service of the packet-switched network 110.

Additional details regarding the processing operations performed by the LLP and NP in an illustrative embodiment will now be provided with reference to FIGS. 4, 5 and 6.

Referring initially to FIG. 4, processing operations are shown for an ATM cell stream comprising an IMA group with N virtual circuits received as an embedded payload of T1/E1 traffic. The LLP 104 receives the IMA group via E1/T1 signal line 202. The LLP performs TDM framing in framer 230, IMA protocol termination in TC/IMA element 208, and mapping of the N virtual circuits of the IMA group as a single bandwidth pipe to an MPHY and channel ID in system interface 214. The corresponding ATM cells are transmitted via interface 107 to the NP as indicated.

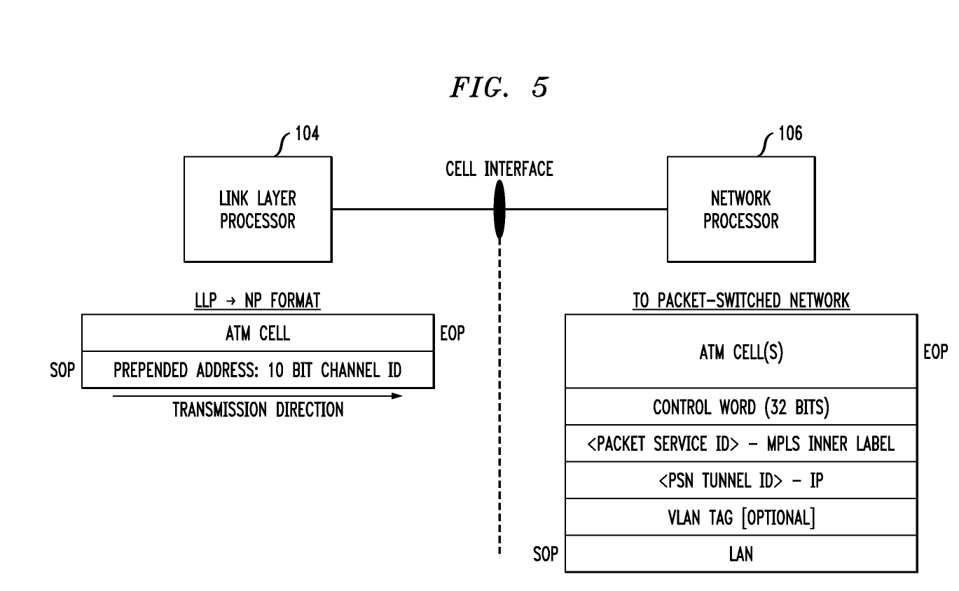

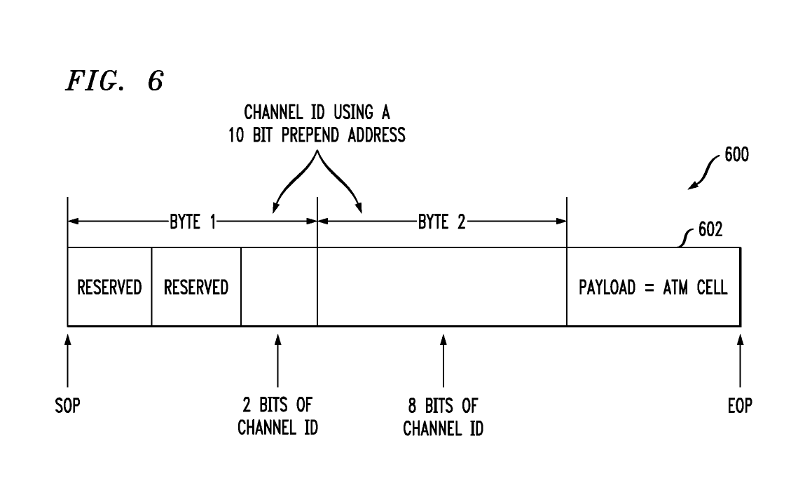

One or more of the ATM cells are transmitted from the LLP 104 to the NP 106 in the format illustrated in FIGS. 5 and 6. FIG. 5 shows a packet formed by the LLP comprising one or more ATM cells and a prepended address comprising a 10-bit channel ID. This packet is shown with start of packet (SOP) and end of packet (EOP) indicators on the LLP side of the cell interface diagram in FIG. 5.

The ATM cells are thus carried over interface 107 in data packets that have respective prepended addresses each given by the associated channel ID to which the corresponding virtual circuits were mapped in system interface 214.

The NP 106 includes a PWE encapsulation element 400 comprising mapping circuitry 402. The mapping circuitry 402 performs the mapping operation in step 306 of FIG. 3 by mapping an MPHY and channel ID to a packet service ID. This mapping circuitry may be part of a PWE service encapsulation portion of the PWE encapsulation element 400. Other portions of the PWE encapsulation element 400 are used to append a tunnel ID to a given packet as per step 308 of FIG. 3. More specifically, this operation can be performed in a PWE tunnel encapsulation portion of the PWE encapsulation element 400.

The NP also includes additional processing elements 404 that in this embodiment provide functionality associated with traffic management, per-flow queuing, SLA (Service Level Agreement) policing, statistics, OAM (Operations, Administration & Maintenance), PWE OAM, and Ethernet processing. Such functionality can be implemented using well-known conventional techniques, and accordingly will not be described in further detail herein.

The data packets received from the LLP 104 are reformatted in the NP 106 in the manner illustrated in the NP portion of the FIG. 5 diagram. More specifically, one or more ATM cells are formatted into a data packet that illustratively comprises a 32-bit control word, a packet service ID in the form of an MPLS inner label, an IP tunnel ID of the packet-switched network 110, an optional virtual local area network (VLAN) tag, and an LAN indicator.

The data packets having the format shown in the NP portion of the FIG. 5 diagram are transmitted by the NP over the packet-switched network 110. In this embodiment, these packets are transmitted utilizing an Ethernet physical layer 410 that carries one or more PWE tunnels 412 as indicated.

The format for a given data packet 600 transmitted between the LLP and the NP is shown in greater detail in FIG. 6. The channel ID to which the N virtual circuits of the IMA group are mapped is prepended to a payload 602 comprising one or more ATM cells of at least one of the N virtual circuits. More specifically, first and second bytes denoted Byte 1 and Byte 2 are used to convey the 10-bit prepended address specifying the channel ID, with 8 bits of the channel ID being inserted in Byte 2 and 2 bits of the channel ID being inserted in Byte 1. Remaining portions of Byte 1 are denoted as reserved.

It should be understood that the particular packet formats shown in FIGS. 5 and 6 are presented by way of illustrative example only, and alternative embodiments may use different packet formats. For example, the particular numbers of bits allocated to the prepended address may be varied in other embodiments. Also, the particular manner in which the address is combined with the ATM cell or cells may vary. As one additional example, this address may be postpended rather than prepended. Both of these terms are intended to fall within the more general term “appended” as used herein.

As indicated previously, the mapping of the plurality of virtual circuits as a single unit is implemented without requiring any processing of virtual channel indicators of the respective virtual circuits. The mapping of the ATM cell stream to one or more packet services is therefore “transparent” with respect to such indicators. Since the need for checking of virtual channel indicators is eliminated, an emulated private line service capability can be provided. Also, a high level of bandwidth efficiency is achieved by ensuring that only those portions of a given T1/E1 line that are currently being used are mapped into a packet stream.

At least a portion of the above-described functionality of the LLP 104 and NP 106 may be implemented in the form of computer program code that is stored in a memory and executed by a processor. For example, program code for performing the mapping operation in step 304 of FIG. 3 may be downloaded from the host processor 114 into memory 218 of the LLP via the microprocessor interface 216 and executed by packet processor 210 within the LLP. Similarly, program code for performing PWE encapsulation operations in the NP may be stored in a memory of the NP and executed by an internal processing element of the NP. Such LLP or NP memories are examples of what are more generally referred to herein as a computer-readable medium or other type of computer program product having computer program code embodied therein, and may comprise, for example, electronic memory such as RAM or ROM, magnetic memory, optical memory, or other types of storage devices in any combination. The internal processing elements of the LLP or NP may comprise a microprocessor, CPU, ASIC, FPGA or other type of processing device, as well as portions or combinations of such devices.

As mentioned previously, LLP 104 and NP 106 may be implemented as respective integrated circuits suitable for installation on a board or card of an otherwise conventional router, switch or other type of network node.

In a given such integrated circuit implementation, identical die are typically formed in a repeated pattern on a surface of a semiconductor wafer. Each die includes at least a portion of a device as described herein, and may include other structures or circuits. The individual die are cut or diced from the wafer, then packaged as an integrated circuit. One skilled in the art would know how to dice wafers and package die to produce integrated circuits. Integrated circuits so manufactured are considered part of this invention.

Again, it should be emphasized that the embodiments of the invention as described herein are intended to be illustrative only. For example, the invention can be implemented using a wide variety of other types of processing device and system configurations. Also, the type of network address or packet service to which multiple virtual circuits are mapped as a single unit may be varied in other embodiments. Furthermore, other processing operations involving alternative packet formats may be used to perform the disclosed mapping.

These and numerous other alternative embodiments within the scope of the following claims will be readily apparent to those skilled in the art.

What is claimed is:

1. A method of processing data traffic of at least one cell stream of a circuit-switched network for transmission over a packet service of a packet-switched network, the method comprising:
receiving data traffic associated with a plurality of virtual circuits of said at least one cell stream;
mapping the plurality of virtual circuits as a single unit to an identifier of a particular packet service of the packet-switched network; and
transmitting the data traffic associated with the virtual circuits over the particular packet service;
wherein the step of mapping the plurality of virtual circuits as a single unit comprises mapping said virtual circuits without requiring any processing of virtual channel indicators of the respective virtual circuits.

2. The method of claim 1 wherein said at least one cell stream comprises at least one ATM cell stream.

3. The method of claim 1 wherein said at least one cell stream is carried as an embedded payload of T1/E1 traffic.

4. The method of claim 1 wherein the step of receiving data traffic associated with the plurality of virtual circuits of said at least one cell stream further comprises the step of terminating the plurality of virtual circuits.

5. The method of claim 4 wherein the virtual circuits comprise at least one UNI port or IMA group that is terminated in the terminating step.

6. The method of claim 1 wherein the step of mapping the plurality of virtual circuits as a single unit to an identifier of a particular packet service of the packet-switched network further comprises the steps of:
mapping the plurality of virtual circuits as a single unit to a network address; and
mapping the network address to the identifier of a particular packet service of the packet-switched network.

7. The method of claim 6 wherein the step of mapping the plurality of virtual circuits as a single unit to a network address further comprises the step of forming at least one packet in a first packet format having a payload portion comprising one or more cells and an appended address portion comprising at least a part of the network address.

8. The method of claim 7 wherein the step of mapping the network address to the identifier of a particular packet service further comprises processing one or more packets received in the first packet format to generate one or more packets in a second packet format having a payload portion comprising one or more cells and further having an appended identifier portion comprising at least a part of the packet service identifier.

9. The method of claim 1 wherein the step of mapping the plurality of virtual circuits as a single unit to an identifier of a particular packet service of the packet-switched network further comprises the steps of:
mapping the plurality of virtual circuits as a single unit to a combination of a physical layer address and a channel identifier; and
mapping the physical layer address and the channel identifier to the identifier of a particular packet service of the packet-switched network.

10. The method of claim 1 wherein the step of transmitting the data traffic associated with the virtual circuits over the particular packet service further comprises the steps of:
associating the packet service identifier with an identifier of a particular tunnel of the packet-switched network; and
transmitting the data traffic associated with the virtual circuits using the particular tunnel of the packet-switched network.

11. The method of claim 10 wherein the tunnel comprises at least one of a PWE tunnel, an IP tunnel and an MPLS tunnel of the packet-switched network transmitted over an Ethernet physical layer.

12. The method of claim 1 wherein the recited steps are performed by at least one integrated circuit of a communication system node coupled between the circuit-switched network and the packet-switched network.

13. The method of claim 6 wherein the steps of receiving data traffic associated with a plurality of virtual circuits and mapping the plurality of virtual circuits as a single unit to a network address are performed by a link layer processor of a communication system node coupled between the circuit-switched network and the packet-switched network.

14. The method of claim 6 wherein the steps of mapping the network address to an identifier of a particular packet service of the packet-switched network and transmitting the data traffic associated with the virtual circuits over the particular packet service are performed by a network processor of a communication system node coupled between the circuit-switched network and the packet-switched network.

15. A computer program product having computer program code embodied therein that when executed by at least one processor of a communication system node causes the node to perform the steps of the method of claim 1.

16. An apparatus comprising:
a processing node adapted for coupling between a circuit-switched network and a packet-switched network of a communication system;
the node comprising at least one processor configured to process data traffic of at least one cell stream of the circuit-switched network for transmission over a packet service of the packet-switched network;
the node being configured to receive data traffic associated with a plurality of virtual circuits of said at least one cell stream, to map the plurality of virtual circuits as a single unit to an identifier of a particular packet service of the packet-switched network, and to transmit the data traffic associated with the virtual circuits over the particular packet service;
wherein the plurality of virtual circuits are mapped as a single unit to the identifier of the particular packet service without requiring any processing of virtual channel indicators of the respective virtual circuits.

17. The apparatus of claim 16 wherein said at least one processor comprises a series combination of a link layer processor and a network processor.

18. The apparatus of claim 16 wherein said at least one processor is implemented as an integrated circuit.

19. An integrated circuit comprising:
at least one processor adapted for coupling between a circuit-switched network and a packet-switched network of a communication system and configured to process data traffic of at least one cell stream of the circuit-switched network for transmission over a packet service of the packet-switched network;
said processor being configured to receive data traffic associated with a plurality of virtual circuits of said at least one cell stream, and to map the plurality of virtual circuits as a single unit to a network address;
wherein the network address is further mapped to an identifier of a particular packet service of the packet-switched network so as to permit the data traffic associated with the virtual circuits to be transmitted over the particular packet service;
wherein the plurality of virtual circuits are mapped as a single unit to the network address without requiring any processing of virtual channel indicators of the respective virtual circuits.

20. The integrated circuit of claim 19 wherein said at least one processor comprises a link layer processor.
